(19) United States
(12) Patent Application Publication
(10) Pub. No.: US 2007/0042098 A1
(43) Pub. Date: Feb. 22, 2007

(54) TOPICALLY APPLIED GARLIC ON REFRIGERATED DOUGH

(76) Inventors: Penny L. Norquist, St. Paul, MN (US); Michael R. Polzin, Plymouth, MN (US); Cam B. Tran, Plymouth, MN (US); Carrie N. Burbrink, Minneapolis, MN (US)

Correspondence Address: GENERAL MILLS, INC., P.O. BOX 1113, MINNEAPOLIS, MN, 55440, US

(21) Appl. No.: 11/464,298

(22) Filed: Aug. 14, 2006

Related U.S. Application Data
(60) Provisional application No. 60/708,514, filed on Aug. 16, 2005.

(51) Int. Cl. A21D 10/00

(52) U.S. Cl. 426/549

(57) ABSTRACT

Refrigerated, raw dough products having topically applied garlic flavorant. The refrigerated, raw dough products, upon baking, have a higher Baked Specific Volume than comparable, raw dough products having garlic flavorant mixed directly into the dough. The garlic flavorant can be used in a solid form, liquid form or a combination of solid and liquid forms. The refrigerated, raw dough products can be formed from either developed or undeveloped dough. The refrigerated raw dough product can be packaged and stored in a refrigerated environment for a period of about 4 to about 12 weeks while maintaining a satisfactory Baked Specific Volume upon baking. The topically applied garlic flavorant can be present in an amount up to about 5.0% by weight of the raw dough product. A process for forming the refrigerated, raw dough product can include applying the garlic flavorant to an exterior portion of the refrigerated, raw dough product.

### PRIORITY CLAIM

The present application claims priority to U.S. Provisional Patent Application Ser. No. 60/708,514 filed Aug. 16, 2005, and entitled “TOPICALLY APPLIED GARLIC ON REFRIGERATED DOUGH”, which is herein incorporated by reference in its entirety.

### FIELD OF THE DISCLOSURE

This disclosure relates generally to refrigerated dough products. In particular, the disclosure relates to a stable refrigerated dough product having topically applied garlic.

### BACKGROUND OF THE DISCLOSURE

Refrigerated dough products such as, for example, crescent rolls, biscuits, bread loaves, bread sticks, pizza crust, dinner rolls and savory bread products, are frequently purchased and consumed by end users due to their ease of storage and preparation. These refrigerated dough products are available in a wide variety of configurations and flavors from companies such as the Pillsbury Division of General Mills, Inc., of Golden Valley, Minn. Refrigerated dough products can be utilized as a pre-made component of a “home cooked” meal such as, for example, pizza dough or can comprise a stand-alone food item such as, for example, a crescent roll or biscuit. Regardless of how the dough products are utilized, many of the dough products are available in multiple taste configurations including any of a wide variety of cheeses such as cheddar or asiago, dairy flavors such as butter or buttermilk or a wide variety of herbs and seasonings.

One especially popular flavor ingredient desired by consumers is garlic flavor. Unfortunately, the addition of garlic to refrigerated dough products in either a solid (e.g., minced, powder, granulated) or liquid (e.g., oil) form has a negative impact upon the processing characteristics of the refrigerated dough as well as the stable storage life of the refrigerated dough product. During processing of refrigerated dough, the addition of garlic during mixing of the dough ingredients can result in a generally sticky dough that is difficult to handle. During storage of a refrigerated dough product that includes garlic mixed into the dough, the refrigerated dough product can also experience a loss in Baked Specific Volume (BSV) over time as well as the development of off-flavors and “gray” dough. Although not wishing to be bound by theory, it is generally believed that these negative effects are caused by chemical reactions within the refrigerated dough wherein compounds present in the garlic begin to breakdown the gluten structure of the refrigerated dough. Further discussion of the effects of garlic on dough can found in an article written by Miller, Hoseney and Soper in the Journal of Food Science, Vol. 62, No. 6, 1997, entitled, “Garlic Effects On Dough Properties,” which is herein incorporated by reference in its entirety.

One method by which garlic has been implemented with refrigerated dough products has been to isolate the garlic from the refrigerated dough until just prior to baking. For example, separately packaged containers or packets of garlic have been included in kits with a refrigerated dough. Upon opening the packaged kit, the garlic can then be applied to the dough as part of the preparation process, immediately prior to baking. Unfortunately, the inclusion of individual garlic packages with the refrigerated dough products adds processing costs while increasing inconvenience to the end user. As such, it would be advantageous to develop refrigerated dough products that incorporate garlic without suffering the aforementioned processing and storage issues while simultaneously eliminating the inconvenience to the end user of adding garlic prior to baking the refrigerated dough.

### SUMMARY OF THE DISCLOSURE

The embodiments of the invention described below are not intended to be exhaustive or to limit the invention to the precise forms disclosed in the following detailed description. Rather, the embodiments are chosen and described so that others skilled in the art may appreciate and understand the principles and practices of the invention.

In a representative embodiment, refrigerated, raw dough products can comprise a topically applied garlic flavorant, where the products have minimal processing and storage problems generally associated with the mixing of garlic into refrigerated dough. By topically applying the garlic flavorant, the garlic is generally prevented from diffusing into the refrigerated dough such that the effect of chemical reactions between the garlic and the gluten structure is minimized if not eliminated. By topically applying the garlic flavorant, the refrigerated dough product is conveniently ready for baking at time of use without requiring an end user to separately add garlic flavor.

In one representative embodiment, a refrigerated raw dough product comprises a topically applied garlic flavorant. The garlic flavorant can be applied in a solid form such as, for example, minced garlic, granulated garlic or garlic powder or alternatively in a liquid form such as, for example, garlic oil, or a combination of both solid and liquid form. Regardless of form, the garlic flavorant can be applied and mixed with a carrier such as, for example, soybean oil to assist in the application and retention of the garlic flavorant. The refrigerated raw dough product can comprise either a developed dough product such as, for example, bread, bagel, croissant or roll dough products or an undeveloped dough product such as, for example, a biscuit dough product. The refrigerated raw dough product can be packaged and stored in a refrigerated environment for up to 90 days while maintaining a Baked Specific Volume (BSV) generally equivalent to a refrigerated raw dough product without added garlic. In some embodiments, refrigerated raw dough products as disclosed herein can comprise a BSV of greater than 2.7 cc/g after 90 days of refrigerated storage. In some presently preferred embodiments, refrigerated raw dough products as disclosed herein can comprise a BSV of greater than 3.0 cc/g after 90 days of refrigerated storage. In some embodiments, the topically applied garlic flavorant can be present in an amount from about 0.01% to about 5.0% percent by weight of the raw dough product. The refrigerated raw dough product can be packaged in pressurized containers such as, for example, a self-sealing can or canister or alternatively, can be package in low-pressure packaging such as, for example, a flexible bag or container.

In another representative embodiment, a process and methods for preparing a refrigerated raw dough product having a topically applied garlic flavorant are described. In some embodiments, the process can comprise adding garlic in a particulate form such as, for example, minced garlic or garlic powder. In some embodiments, the process can comprise adding garlic in a liquid form such as, for example, garlic oil. In some embodiments, the garlic flavorant, in either a liquid or solid form, can be mixed and/or otherwise combined with a carrier to assist with application and retention of the garlic flavorant. In some embodiments, a carrier can comprise a vegetable oil such as, for example, soybean oil.

In another aspect of the disclosure, a method for forming a garlic-flavored, refrigerated raw dough product can comprise formation of a raw dough intermediate followed by topical application of a garlic flavorant to the raw dough intermediate. Application of the garlic flavorant can include application of garlic flavorant in either a solid or liquid form and can further comprise providing the garlic flavorant in combination with a carrier such as, for example, soybean oil. Application of the garlic flavorant is preferably accomplished downstream of the raw dough intermediate formation so as to avoid “contamination” of the production line with the garlic flavorant.

As used throughout the specification and claims, the term “refrigerated raw dough product” refers to raw dough-based products, such as rolls, biscuits, bread loaves, breadsticks, pizza crust and savory bread products that are capable of refrigerated storage for extended periods of time and that require a further thermal processing or baking step by the end user prior to consumption. Refrigerated raw dough products as used herein refer to dough products that have either a developed or undeveloped gluten structure.

As used throughout the specification and claims, the term “garlic flavorant” refers to both solid garlic forms such as, for example, minced garlic and garlic powder as well as liquid garlic forms such as, for example, garlic oil.

As used throughout the specification and claims, the term “dough intermediate” refers to an individual dough unit such as, for example, an individual biscuit or roll present in an intermediate state requiring further thermal processing or baking prior to consumption by an end user.

As used through the specification and claims, the terms “topical”, “topically” and “exterior” may be used interchangeably to refer to flavorant positioning on dough products having a garlic flavorant applied to an outer surface or perimeter of the raw dough product as opposed to being mixed into the raw dough product.

As used throughout the specification and claims, the term “stable” refers to desirable characteristics of a refrigerated, raw dough which, characterize the dough as being of and maintaining an acceptable quality. The term “stable” can be applied to objective baking properties associated with the refrigerated raw dough such as, for example, the capability of achieving a desired Baked Specific Volume (BSV) after a specified period of refrigerated storage. The term “stable” can also be applied to more subjective properties of the refrigerated, raw dough such as, for example, a stable refrigerated, raw dough can exhibit consistent, desirable flavor qualities and/or dough color such as, for example, the avoidance of “grey” dough and or off-flavor, during a storage period without deterioration.

### BRIEF DESCRIPTION OF THE FIGURES

These, as well as other objects and advantages of this disclosure, will be more completely understood and appreciated by referring to the following more detailed description of the presently preferred exemplary embodiments of the invention in conjunction with the accompanying drawings, of which:

FIG. 1 is a flow schematic illustrating a representative method for forming a garlic flavored raw dough product of the invention.

FIG. 2 is a bar graph illustrating the Baked Specific Volume of various Crusty French Loaf dough samples at designated time intervals.

FIG. 3 is a bar graph illustrating the Baked Specific Volume of various Crescent Roll dough samples at designated time intervals.

### DETAILED DESCRIPTION OF THE DISCLOSURE

Presently contemplated, representative embodiments of refrigerated dough products are now illustrated in greater detail by way of the following detailed description, but it should be understood that the disclosure is not to be construed as being limited thereto.

Surprisingly, it has been found that by applying garlic flavorant, in either a liquid or solid form or both in combination, to an exterior surface of a refrigerated, raw dough product prior to packaging, the refrigerated, raw dough product can be refrigerated for periods of up to ninety days while maintaining a Baked Specific Volume (BSV) upon baking of the raw dough product either generally equivalent to or within an acceptable range of a refrigerated, raw dough lacking garlic flavorant. BSV is a term of art in the industry that defines the inverse of density or fluffiness of a baked good, and is simply the volume of the baked product divided by its weight. By applying garlic flavorant to the exterior surface, garlic diffusion through the dough is generally reduced or eliminated such that the chemical reactions typically experienced when garlic is mixed into refrigerated, raw dough can be avoided resulting in a stable product with no off-flavors.

As described throughout the specification, the attainment of certain dough characteristics are more important in some dough than in others, and depend largely on the intended end use of the dough product. It will be understood that the topical application of garlic flavorant, in either a solid or liquid form, applies equally to refrigerated, raw dough products that are formed as either developed dough or undeveloped dough. Developed dough is that in which a protein or gluten network has been more or less fully formed or created. Representative examples of developed dough can include dough for breads, bagels, croissant or rolls. Undeveloped dough is that which may lack sufficient protein or gluten to form a gluten network. One representative example of undeveloped dough is biscuit dough.

Dough formulations, and the ingredients they contain, can differ depending on the finished product that is obtained from the dough. However, most dough generally have a number of ingredients in common and examples of some such common ingredients are described and illustrated in more detail below.

Dough as described and referenced herein generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Bread flours are primarily milled from hard red winter or spring wheat. Generally these flours have a protein content of about 11.0-12.5%. Certain baked products may require stronger bread flours with about 1-2% higher protein content.

In bread making, flour may comprise up to about 95 weight percent of the dry ingredients. In bread, when the flour comes in contact with water, and the ingredients are mixed, the gluten protein fraction forms elastic, gas-retaining films.

Dough compositions can be caused to expand (leaven) by any leavening mechanism, such as by one or more of the effects of: entrapped gas such as entrapped carbon dioxide, entrapped oxygen, or both; a laminated dough structure; by action of chemical leavening agents; or by action of a biological agent such as a yeast. Thus, a leavening agent may be an entrapped gas such as layers or cells (bubbles) that contain carbon dioxide, water vapor, or oxygen, etc.; any type of yeast (e.g., cake yeast, cream yeast, dry yeast, etc.); or a chemical leavening system, e.g., containing a basic chemical leavening agent and an acidic chemical leavening agent that react to form a leavening gas such as carbon dioxide.

Examples of acidic chemical leavening agents are generally known in the dough and bread-making arts, with examples including sodium aluminum phosphate (SALP), sodium acid pyrophosphate (SAPP), monosodium phosphate, monocalcium phosphate monohydrate (MCP), anhydrous monocalcium phosphate (AMCP), dicalcium phosphate dihydrate (DCPD), glucono-delta-lactone (GDL), as well as a variety of others. Optionally, an acidic chemical leavening agent for use in accordance with the present disclosure can be encapsulated.

Examples of basic chemical leavening agents include many that are generally known in the dough and baking arts, such as soda, i.e., sodium bicarbonate (NaHCO3), potassium bicarbonate (KHCO3), ammonium bicarbonate (NH4HCO3), etc. A basic chemical leavening agent may also be encapsulated, if desired.

The evolution of carbon dioxide essentially follows the stoichiometry of typical acid-base reactions. The amount of leavening base present determines the amount of carbon dioxide evolved, whereas the type of leavening acid affects the speed at which the carbon dioxide is liberated. The amount of leavening base used in combination with the leavening acid can be balanced such that a minimum of unchanged reactants remain in the finished product. An excess amount of leavening base can impart a bitter flavor to the final product, while excess leavening acid can make the baked product tart.

Yeast is also utilized for leavening baked goods, and is often preferred because of the desirable flavor it imparts to the dough. Baker's yeast is generally supplied in three forms: yeast cream, a thick suspension with about 17% solids; a moist press cake with about 30% solids; and an active dry yeast, with about 93 to 98% solids. Generally, active dry yeasts of acceptable quality have been available for some time, and recently instant active dry yeast has also been available for commercial use.

The quantity of yeast added to dough is directly related to the time required for fermentation, and the form of the yeast utilized. Generally, most bread doughs are made with from about 2 to 3% fresh compressed yeast, based on the amount of flour.

Suitable dough as used herein can also constitute additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Either natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough-developing agents can also be added to the system to increase dough viscosity, texture and plasticity. Any number of agents known to those of skill in the art may be used including azodicarbonamide, diacetyl tartaric acid ester of mono- and diglycerides (D.A.T.E.M.) and potassium sorbate.

Another example of a dough-developing additive is PROTASE™. PROTASE™ is a proprietary product containing enzymes and other dough conditioners. PROTASE™ is generally used to reduce mixing time and improve machinability. A double strength version, PROTASE 2™, is commercially obtained from J. R. Short Milling Co. (Chicago, Ill.).

Dough conditioners are also examples of dough additives. One example of a dough conditioner is NUBAKE™, commercially available from RIBUS (St. Louis, Mo.). Another example of a dough conditioner is L-cysteine, commercially available from B.F. Goodrich (Cincinnati, Ohio).

Dough can also frequently contain nutritional supplements such as vitamins, minerals and proteins, for example. Examples of specific nutritional supplements include thiamin, riboflavin, niacin, iron, calcium, or mixtures thereof.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Methods of forming the roll-style dough product of the present disclosure can include one or more of the following steps including combining ingredients for a dough in a mixing system, configured so that the atmosphere can be, if desired, controlled, optionally controlling the atmosphere in the mixing system, and mixing the ingredients to form a resulting dough.

Representative methods for mixing dough can include but not be limited to a straight dough method, and a sponge and dough method. Mixing details can therefore depend in part on the type of dough that is being mixed, and the method of mixing that is generally used with that type of dough. For example, some chemically leavened doughs require a two step process. Methods can also incorporate varied mixing times. The time a dough is mixed using the presently contemplated methods can depend in part on the type of dough that is being mixed and the general process that is being used.

Generally, the step of combining the ingredients in the mixing system depends on the particular ingredients, the type of dough being mixed, the type of process being used, and the type of mixing system being used. One of skill in the art, having read this specification, would know based on the ingredients being used, the type of process being used, and the type of mixing system being used, and how to accomplish this step.

In addition to adding garlic flavorant, other commonly used flavorants can be added to the raw dough such as, for example, dairy flavors, fruit flavors, nut based flavors, spices, seasonings, herbs, vegetables, cocoa-based flavors, vanilla, salt, sweet flavors and sweeteners. Suitable dairy flavors can include butter, cream, sour cream, custard, buttermilk and a variety of cheeses including cream cheese, parmesan, Romano, asiago, cheddar, mozzarella, Swiss and the like. Suitable fruit flavors can include raspberry, blueberry, blackberry, strawberry, apple, pineapple, peach, cherry, citrus, coconut and the like. Suitable nut-based flavors can include walnut, pecan, almond, peanut, macadamia nut and the like. Suitable spices can include cinnamon, nutmeg, clove and the like. Suitable herbs can include basil, oregano, thyme, rosemary and Italian blend. Suitable vegetables can include onion, garlic, peppers, tomato and the like. Suitable sweet flavors and sweeteners can include honey, caramel, maple, butterscotch, molasses, sugar, brown sugar, corn syrup, sugar-replacement sweeteners and the like.

When garlic flavorant, in either a dry or liquid form or both, is mixed into a raw dough during dough formation, the garlic flavorant interacts with the dough resulting in a loss of dough quality over time. More specifically, garlic flavorant interacts with a raw dough during refrigerated storage so as to negatively effect the gluten structure such that upon baking of the raw dough, a baked product can have a significantly reduced and unacceptable Baked Specific Volume when compared to a baked product from a similar raw dough in which the garlic flavorant has not been added. In addition, the garlic flavorant can chemically interact with the raw dough during refrigerated storage resulting in the formation of sulfur-based compounds causing the raw dough to exhibit off-flavor characteristics. In addition to the negative effects associated with Baked Specific Volume and off-flavor characteristics, it has generally been found that refrigerated dough products having garlic mixed directly into the dough can exhibit a soft and/or soupy dough consistency and can over time develop a color change wherein the dough becomes grey colored in appearance.

For purposes of further describing the garlic-flavored, refrigerated raw dough products of the present disclosure, reference is made to the following illustrative examples.

Illustrative Garlic Flavorant Example 1

One objective measurement for illustrating the negative effects of garlic flavorant mixed into raw dough is further illustrated in the following tables showing the effects of mixed garlic flavorant on Baked Specific Volume using Pillsbury® Crusty French Loaf (CFL) refrigerated bread dough. Two similar but independent experiments were conducted in which a control sample of CFL dough was compared to a variety of CFL dough samples in which varying amounts and types of garlic flavorant were mixed directly into the raw, CFL dough. The garlic flavorant was provided as garlic powder or garlic oil and was added to the CFL dough samples in an amount ranging from about 0.28% to about 3.34% by weight of the raw dough. With the exception of varying garlic flavorant amounts, each dough was formed and placed into refrigerated storage in a substantially identical manner. After 3 weeks, 8 weeks and 12 weeks of refrigerated storage, portions of each dough were baked and the Baked Specific Volume for each was determined. As illustrated in Tables 1A and 1B, mixing garlic flavorant directly into the raw dough results in unacceptable deterioration of the Baked Specific Volume as compared to the non-garlic flavored, control dough.

TABLE 1A
Baked Specific Volumes from Experiment 1 with Refrigerated,
Crusty French Loaf Dough having Garlic Mixed in Dough After
4, 8 and 12 Weeks of Refrigerated Storage

| | | | BSV after 4 | BSV after 8 | BSV after 12 |
|---|---|---|---|---|---|
| | | | weeks of | weeks of | weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CFL Control Sample A | NA | NA | 4.15 | 3.70 | 3.25 |
| CFL Garlic Sample #1 | Garlic | 0.28% | 2.76 | 3.53⁽¹⁾ | 2.55 |
| | Powder | | | | |
| CFL Garlic Sample #2 | Garlic Oil | 0.28% | 2.36 | 2.35 | 2.41 |
| CFL Garlic Sample #3 | Garlic | 0.84% | 2.45 | 2.21 | 2.36 |
| | Powder | | | | |
| CFL Garlic Sample #4 | Garlic Oil | 0.84% | 2.34 | 2.37 | 2.38 |

⁽¹⁾It is believed that an error occurred during the determination of BSV at 8 weeks for CFL Garlic Sample #1.

TABLE 1B
Baked Specific Volumes from Experiment 2 with Refrigerated,
Crusty French Loaf Dough having Garlic Mixed in Dough After
4, 8 and 12 Weeks of Refrigerated Storage

| | | | BSV after 4 | BSV after 8 | BSV after 12 |
|---|---|---|---|---|---|
| | | | weeks of | weeks of | weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CFL Control Sample B | NA | NA | 3.71 | 3.35 | 2.83 |
| CFL Garlic Sample #5 | Garlic | 0.84% | 2.46 | 2.64 | 2.70 |
| | Powder | | | | |
| CFL Garlic Sample #6 | Garlic | 3.34% | 2.57 | 2.51 | 2.82 |
| | Powder | | | | |
| CFL Garlic Sample #7 | Garlic Oil | 0.84% | 2.89 | 2.95 | 3.13 |
| CFL Garlic Sample #8 | Garlic Oil | 1.46% | 2.98 | 3.02 | 3.24 |

In contrast to the refrigerated raw dough products having garlic mixed directly into the dough as discussed above, it has been surprisingly discovered that a topical application of garlic flavorant to a refrigerated raw dough product does not suffer the same negative effects on Baked Specific Volume, appearance, taste and dough consistency. The garlic flavorant can be supplied in either a solid form such as garlic powder or in a liquid form such as garlic oil. In addition, the garlic flavorant, present in either a solid or liquid form, can be mixed with a carrier such as, for example, soybean oil, which can assist during application and retention of the garlic flavorant on the refrigerated raw dough product.

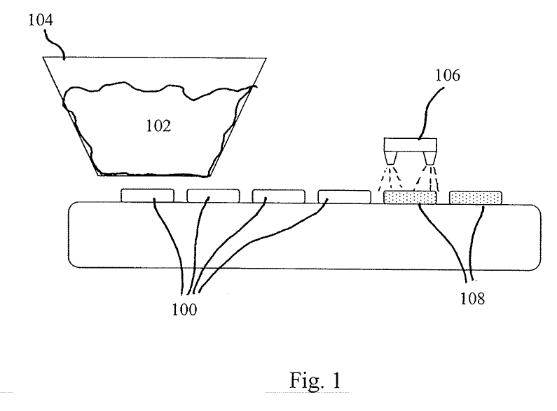

In addition to the dough characteristic advantages referred to above, the topical application of garlic flavorant can provide for improved processing flexibility as compared to dough products that would include garlic mixed directly into the dough. As illustrated schematically in FIG. 1, a dough intermediate 100 can be formed from a dough 102 in a formation step 104. The formation step 104 generally involves the addition and mixing of dough ingredients as described previously. Once the formation step 104 is completed, garlic flavorant is topically applied to the dough intermediate 100 in a garlic application step 106 to form a garlic-flavored raw dough product 108. Typically, garlic application step 106 involves spraying or sprinkling the garlic flavorant onto the dough intermediate 100. The garlic flavorant can comprise a solid form such as garlic powder or a liquid form such as garlic oil. In some embodiments, the garlic flavorant, in either the solid or liquid form, can be mixed with a carrier such that the carrier and garlic flavorant are sprayed onto the dough intermediate 100 at the end of a processing line. Representative carriers can be selected from appropriate vegetable oils such as, for example, soybean oil. By applying the garlic flavorant at the end of the processing line, “contamination” of the preceding components of the processing line can be avoided such that the same processing line can be used to make both garlic flavored refrigerated dough products as well as non-garlic flavored dough products.

Garlic-flavored raw dough product 108 can be packaged, shipped and stored in packaging suitable for refrigerated storage period of up to 90 days. Generally, suitable packaging can comprise pressurized containers such as, for example, a self-sealing can or canister or alternatively, low-pressure packaging such as, for example, a flexible bag or container.

To illustrate the surprising advantages of the present invention, two similar experiments were independently conducted in which a variety of CFL dough samples having varying amounts and types of garlic flavorant applied to an exterior portion of the raw, CFL dough were compared to a control CFL dough sample. The garlic flavorant was provided either as garlic powder or garlic oil and was applied to the exterior of the CFL dough samples in an amount ranging from about 0.28% to about 3.34% by weight of the raw dough. The garlic powder and garlic oil were mixed with soybean oil to serve as a carrier during application and retention of the garlic flavorant on the raw, CFL dough. With the exception of varying garlic flavorant amounts, each dough was formed and placed into refrigerated storage in a substantially identical manner. After 4 weeks, 8 weeks and 12 weeks of refrigerated storage, portions of each dough were baked and the Baked Specific Volume for each was determined. The results of the two experiments are summarized in Table 2A and Table 2B below. As illustrated in both Table 2A and Table 2B, the exterior application of garlic flavorant on the raw dough results in the raw dough maintaining substantially higher Baked Specific Volume as compared to dough samples having garlic flavorant mixed into the raw dough.

TABLE 2A
Baked Specific Volumes from Experiment 1 with Refrigerated,
Crusty French Loaf Dough having Garlic Applied to the Dough
Exterior After 4, 8 and 12 Weeks of Refrigerated Storage

| | | | BSV after 4 | BSV after 8 | BSV after |
|---|---|---|---|---|---|
| | | | weeks of | weeks of | 12 weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CFL Control Sample A | NA | NA | 4.15 | 3.70 | 3.25 |
| CFL Garlic Sample #9 | Garlic | 0.28% | 3.58 | 3.16 | 3.37 |
| | Powder | | | | |
| CFL Garlic Sample #10 | Garlic Oil | 0.28% | 3.92 | 3.55 | 3.39 |
| CFL Garlic Sample #11 | Garlic | 0.84% | 3.81 | 3.21 | 2.95 |
| | Powder | | | | |
| CFL Garlic Sample #12 | Garlic Oil | 0.84% | 3.92 | 3.24 | 3.28 |

TABLE 2B
Baked Specific Volumes from Experiment 2 with Refrigerated,
Crusty French Loaf Dough having Garlic Applied to the Dough
Exterior After 4, 8 and 12 Weeks of Refrigerated Storage

| | | | BSV after 4 | BSV after 8 | BSV after |
|---|---|---|---|---|---|
| | | | weeks of | weeks of | 12 weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CFL Control Sample B | NA | NA | 3.71 | 3.35 | 2.83 |
| CFL Garlic Sample #13 | Garlic Powder | 0.84% | 3.49 | 3.42 | 3.40 |
| CFL Garlic Sample #14 | Garlic Powder | 3.34% | 3.25 | 3.29 | 3.46 |
| CFL Garlic Sample #15 | Garlic Oil | 0.84% | 3.70 | 3.48 | 3.54 |
| CFL Garlic Sample #16 | Garlic Oil | 1.46% | 3.63 | 3.60 | 3.60 |

In order to more clearly demonstrate the surprising results of the present invention, a comparison of the BSV results for the samples having garlic flavorant both mixed directly into the dough as well as applied to the exterior of the dough are summarized in Table 3 below. With the lone exception of the 8 week comparison of the dough samples flavored with 0.28% by weight of garlic, in which a testing error is believed to have occurred, every sample having externally applied garlic flavorant showed a BSV improvement of at least 11% when compared to the corresponding dough having garlic mixed into the dough.

TABLE 3
Comparison of Baked Specific Volumes for Refrigerated, Crusty
French Loaf Dough With Garlic Applied to the Dough Exterior versus Garlic
Mixed into the Dough at 4, 8 and 12 Weeks of Refrigerated Storage

| | | Percent | | Percent |
|---|---|---|---|---|
| | | Improvement in | | Improvement in |
| | | BSV for Exterior | | BSV for Exterior |
| | | Applied Garlic | Percent Improvement | Applied Garlic |
| | | compared to Mixed | in BSV for Exterior | compared to |
| | CFL | Garlic after 4 | Applied Garlic | Mixed Garlic |
| | Dough | weeks of | compared to Mixed | after 12weeks of |
| | Sample | refrigerated | Garlic after 8 weeks | refrigerated |
| Garlic Flavorant | Numbers | Storage | of refrigerated Storage | Storage |
| Garlic Powder | 1 and 9 | 29.7% | −11.7% | 32.2% |
| 0.28% by weight | | | | |
| Garlic Oil | 2 and 10 | 66.1% | 51.1% | 40.1% |
| 0.28% by weight | | | | |
| Garlic Powder | 3 and 11 | 55.5% | 45.2% | 25.0% |
| 0.84% by weight | 5 and 13 | 41.9% | 29.5% | 25.9% |
| Garlic Oil | 4 and 12 | 67.5% | 36.7% | 37.8% |
| 0.84% by weight | 7 and 15 | 28.0% | 18.0% | 13.1% |
| Garlic Oil | 8 and 16 | 21.8% | 19.2% | 11.1% |
| 1.46% by weight | | | | |
| Garlic Powder | 6 and 14 | 26.4% | 31.1% | 22.7% |
| 3.34% by weight | | | | |

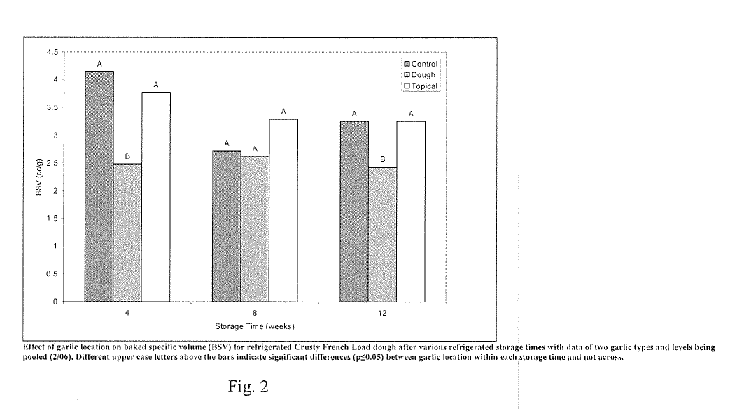

With the exception of the Week 8 data for garlic powder present at an amount of 0.28% by weight, every other comparison demonstrated that the use of externally applied garlic flavorant on a CFL dough product had a higher BSV upon baking than the corresponding CFL dough product having garlic mixed directly into the dough. This BSV improvement was present regardless of storage time, garlic flavorant form or garlic flavorant concentration. In order to further demonstrate the surprising results of the present disclosure, BSV values were averaged for each of the tested storage times. Data for each of the storage times was pooled regardless of garlic flavorant form or garlic flavorant concentration. The resulting average BSV values for the CFL dough products are summarized in Table 4 below and depicted graphically in FIG. 2. From Table 4 and FIG. 2, it can be seen that the application of garlic flavorant to an exterior portion of the CFL dough had a significant increase in BSV upon baking as compared to a CFL dough having garlic mixed directly into the dough.

TABLE 4
Average Baked Specific Volume for Refrigerated, Crusty French
Loaf Dough after 4, 8, and 12 weeks of refrigerated storage

| | BSV after | BSV after | BSV after |
|---|---|---|---|
| | 4 weeks of | 8 weeks of | 12 weeks of |
| | refrigerated | refrigerated | refrigerated |
| | storage | storage | storage |
| Dough Sample | (cc/g) | (cc/g) | (cc/g) |
| Control | 4.15 | 2.72 | 3.25 |
| Dough with Mixed | 2.48 | 2.62 | 2.43 |
| Garlic | | | |
| Dough with Exterior | 3.77 | 3.29 | 3.25 |
| Garlic | | | |

Illustrative Garlic Flavorant Example 2

In order to further illustrate the present invention, similar experiments were conducted with a second dough to again illustrate the effects of garlic on Baked Specific Volume. Two similar but independent experiments were conducted in which a control sample of Pillsbury® Crescent Roll (CR) refrigerated dough was compared to a variety of CR dough samples in which varying amounts and types of garlic flavorant were mixed directly into the raw, CR dough. The garlic flavorant was again provided as garlic powder or garlic oil and was added to the CR dough samples in an amount ranging from about 0.28% to about 3.34% by weight of the raw dough. With the exception of varying garlic flavorant amounts, each dough was formed and placed into refrigerated storage in a substantially identical manner. After 3 weeks, 8 weeks and 12 weeks of refrigerated storage, portions of each dough were baked and the Baked Specific Volume for each was determined. As illustrated in Tables 5A and 5B, mixing garlic flavorant directly into the raw dough results in unacceptable deterioration of the Baked Specific Volume as compared to the non-garlic flavored, control dough.

TABLE 5A
Baked Specific Volumes from Experiment 1 with Refrigerated,
Crescent Roll Dough having Garlic Mixed in Dough After 4, 8
and 12 Weeks of Refrigerated Storage

| | | | BSV after 4 | BSV after 8 | BSV after 12 |
|---|---|---|---|---|---|
| | | | weeks of | weeks of | weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CR Control Sample A | NA | NA | 2.75 | 2.96 | 3.08 |
| CR Garlic Sample #1 | Garlic Powder | 0.28% | 2.60 | 2.80 | 2.60 |
| CR Garlic Sample #2 | Garlic Oil | 0.28% | 2.86 | 2.79 | 2.81 |
| CR Garlic Sample #3 | Garlic Powder | 0.84% | 2.52 | 2.77 | 2.65 |
| CR Garlic Sample #4 | Garlic Oil | 0.84% | 2.70 | 2.67 | 2.63 |

TABLE 5B
Baked Specific Volumes from Experiment 2 with Refrigerated,
Crescent Roll Dough having Garlic Mixed in Dough After 4, 8
and 12 Weeks of Refrigerated Storage

| | | | BSV after 4 | BSV after 8 | BSV after 12 |
|---|---|---|---|---|---|
| | | | weeks of | weeks of | weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CR Control Sample B | NA | NA | 3.25 | 3.07 | N/A⁽²⁾ |
| CR Garlic Sample #5 | Garlic Powder | 0.84% | 2.59 | 2.45 | 2.53 |
| CR Garlic Sample #6 | Garlic Powder | 3.34% | 3.04 | 2.66 | 2.63 |
| CR Garlic Sample #7 | Garlic Oil | 0.84% | 3.45 | 2.88 | 2.73 |
| CR Garlic Sample #8 | Garlic Oil | 1.46% | 3.11 | 3.02 | 2.49 |

⁽²⁾The 12 week CR Control Sample B was lost prior to measuring BSV.

To demonstrate the effectiveness of applying garlic flavorant to an exterior portion of the raw, CR dough samples, two similar experiments were again conducted. The garlic flavorant was provided either as garlic powder or garlic oil and was applied to the exterior of the CFL dough samples in an amount ranging from about 0.28% to about 3.34% by weight of the raw dough. The garlic powder and garlic oil were mixed with soybean oil to serve as a carrier during application and retention of the garlic flavorant on the raw, CR dough. With the exception of varying garlic flavorant amounts, each dough was formed and placed into refrigerated storage in a substantially identical manner. After 4 weeks, 8 weeks and 12 weeks of refrigerated storage, portions of each dough were baked and the Baked Specific Volume for each was determined. The results of the two experiments are summarized in Table 6A and Table 6B below. As illustrated in both Table 6A and Table 6B, the exterior application of garlic flavorant on the raw dough results in the raw dough maintaining substantially higher Baked Specific Volume as compared to dough samples having garlic flavorant mixed into the raw dough.

TABLE 6A
Baked Specific Volumes from Experiment 1 with Refrigerated,
Crescent Roll Dough having Garlic Applied to the Dough Exterior
After 4, 8 and 12 Weeks of Refrigerated Storage

| | | | BSV after 4 | BSV after 8 | BSV after |
|---|---|---|---|---|---|
| | | | weeks of | weeks of | 12 weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CR Control Sample A | NA | NA | 2.75 | 2.96 | 3.08 |
| CR Garlic Sample #9 | Garlic Powder | 0.28% | 2.70 | 3.04 | 2.70 |
| CR Garlic Sample #10 | Garlic Oil | 0.28% | 3.06 | 3.05 | 3.27 |
| CR Garlic Sample #11 | Garlic Powder | 0.84% | 2.93 | 3.10 | 2.82 |
| CR Garlic Sample #12 | Garlic Oil | 0.84% | 2.98 | 3.18 | 2.89 |

TABLE 6B
Baked Specific Volumes from Experiment 2 with Refrigerated,
Crescent Roll Dough having Garlic Applied to the Dough Exterior
After 4, 8 and 12 Weeks of Refrigerated Storage

| | | | BSV after 4 | BSV after 8 | BSV after |
|---|---|---|---|---|---|
| | | | weeks of | weeks of | 12 weeks of |
| | | Garlic | refrigerated | refrigerated | refrigerated |
| | | Weight | storage | storage | storage |
| Dough Sample | Garlic Type | Percent | (cc/g) | (cc/g) | (cc/g) |
| CR Control Sample B | NA | NA | 3.25 | 3.07 | N/A⁽³⁾ |
| CR Garlic Sample #13 | Garlic Powder | 0.84% | 3.05 | 2.70 | 2.74 |
| CR Garlic Sample #14 | Garlic Powder | 3.34% | 2.92 | 2.79 | 2.66 |
| CR Garlic Sample #15 | Garlic Oil | 0.84% | 3.53 | 3.18 | 2.78 |
| CR Garlic Sample #16 | Garlic Oil | 1.46% | 3.57 | 3.13 | 3.15 |

(2) The 12 week CR Control Sample B was lost prior to measuring BSV.

In order to more clearly demonstrate the surprising results of the present invention, a comparison of the BSV results for the samples having garlic flavorant both mixed directly into the dough as well as applied to the exterior of the dough are summarized in Table 7 below. With the exception of the 4 week sample using 3.34% by weight of garlic powder, every sample having externally applied garlic flavorant showed a BSV improvement when compared to the corresponding dough sample having equal amounts of garlic mixed into the dough.

TABLE 7
Comparison of Baked Specific Volumes for Refrigerated, Crescent
Roll Dough With Garlic Applied to the Dough Exterior versus Garlic
Mixed into the Dough at 4, 8 and 12 Weeks of Refrigerated Storage

| | | | | Percent |
|---|---|---|---|---|
| | | | Percent | Improvement in |
| | | Percent | Improvement in | BSV for |
| | | Improvement in | BSV for Exterior | Exterior |
| | | BSV for Exterior | Applied Garlic | Applied Garlic |
| | | Applied Garlic | compared to Mixed | compared to |
| | | compared to Mixed | Garlic after 8 | Mixed Garlic |
| | CR Dough | Garlic after 4 weeks | weeks of | after 12weeks of |
| | Sample | of refrigerated | refrigerated | refrigerated |
| Garlic Flavorant | Numbers | Storage | Storage | Storage |
| Garlic Powder | 1 and 9 | 3.8% | 8.6% | 3.8% |
| 0.28% by weight | | | | |
| Garlic Oil | 2 and 10 | 7.0% | 9.3% | 16.4% |
| 0.28% by weight | | | | |
| Garlic Powder | 3 and 11 | 16.3% | 11.9% | 6.4% |
| 0.84% by weight | 5 and 13 | 17.8% | 10.2% | 8.3% |
| Garlic Oil | 4 and 12 | 10.4% | 19.1% | 9.9% |
| 0.84% by weight | 7 and 15 | 2.3% | 10.4% | 1.8% |
| Garlic Oil | 8 and 16 | 14.8% | 3.6% | 26.5% |
| 1.46% by weight | | | | |
| Garlic Powder | 6 and 14 | −4.1% | 4.9% | 1.1% |
| 3.34% by weight | | | | |

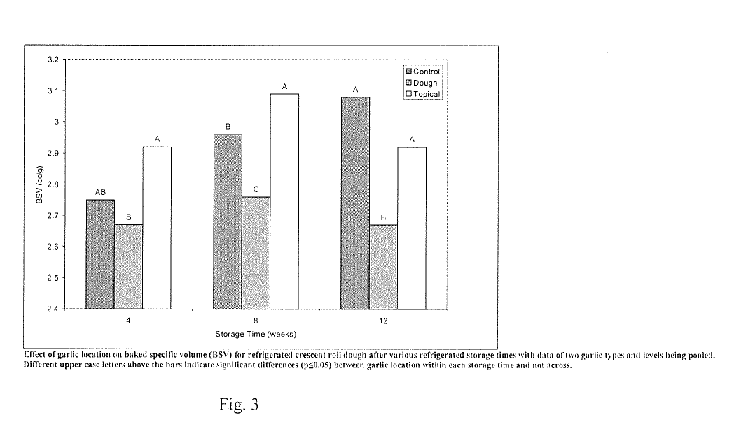

With the exception of the Week 4 data for garlic powder present at an amount of 3.34% by weight, every other comparison demonstrated that the use of externally applied garlic flavorant on a CR dough product had a higher BSV upon baking than the corresponding CR dough product having garlic mixed directly into the dough. This BSV improvement was present regardless of storage time, garlic flavorant form or garlic flavorant concentration. In order to further demonstrate the surprising results of the present disclosure, BSV values were averaged for each of the tested storage times. Data for each of the storage times was pooled regardless of garlic flavorant form or garlic flavorant concentration. The resulting average BSV values for the CR dough products are summarized in Table 8 below and depicted graphically in FIG. 3. From Table 8 and FIG. 3, it can be seen that the application of garlic flavorant to an exterior portion of the CR dough had a significant increase in BSV upon baking as compared to a CR dough having garlic mixed directly into the dough.

TABLE 8
Baked Specific Volume for Refrigerated, Crescent Roll
Dough after 4, 8, and 12 weeks of refrigerated storage

| | BSV after | BSV after | BSV after |
|---|---|---|---|
| | 4 weeks of | 8 weeks of | 12 weeks of |
| | refrigerated | refrigerated | refrigerated |
| | storage | storage | storage |
| Dough Sample | (cc/g) | (cc/g) | (cc/g) |
| Control | 2.75 | 2.96 | 3.08 |
| Dough with Mixed | 2.67 | 2.76 | 2.67 |
| Garlic | | | |
| Dough with Exterior | 2.92 | 3.09 | 2.92 |
| Garlic | | | |

For many refrigerated, raw dough products including the Pillsbury CFL and CR dough used in Illustrative Examples 1 and 2 above, a generally preferred value for BSV is about 3.0 cc/g, while a minimally acceptable BSV value is generally about 2.7 cc/g. For many refrigerated, raw dough products, a BSV value of below 2.7 cc/g is often considered unacceptable. These BSV values generally apply to both refrigerated, raw developed dough products as well as refrigerated, raw undeveloped dough products. Furthermore, to remain acceptable, these same refrigerated, raw dough products must generally maintain these minimally acceptable BSV levels for at least 8 weeks of refrigerated storage, and more preferably for at least 12 weeks of refrigerated storage.

As illustrated in Tables 2A, 2B, 5A and 5B, the application of garlic flavorant to a dough exterior allows for the preparation of storage of refrigerated garlic-flavored bread dough products having acceptable BSV values over a 12 week refrigerated storage life. While the effects are more pronounced with CFL dough than the CR dough, Tables 3 and 6 demonstrate that the application of garlic flavorant to the exterior portion of a refrigerated, raw dough product results in higher BSV values when compared to refrigerated, raw dough products having garlic flavorant mixed directly into the dough.

While the disclosure has been prepared in connection with what is presently considered to be the most practical and preferred embodiments, it will be apparent to those of ordinary skill in the art that the disclosure is not to be limited solely to the presently disclosed and described embodiments, that many modifications and equivalent arrangements may be made thereof within the scope of the present disclosure, which scope is to be accorded the broadest interpretation of the appended claims so as to encompass all equivalent structures and products.

What is claimed:

1. A refrigerated raw dough product comprising: an amount of refrigerated, raw dough comprising a garlic flavorant applied to an exterior surface of the dough; and wherein the dough is stable for at least 4 weeks of refrigerated storage, and the dough, upon baking, has a Baked Specific Volume exceeding a second Baked Specific Volume of a comparable second dough having the garlic flavorant mixed directly into the comparable second dough.

2. The refrigerated raw dough product of claim 1, wherein the garlic flavorant is selected from the group comprising: minced garlic, granulated garlic, garlic powder, garlic oil and combinations thereof.

3. The refrigerated raw dough product of claim 1, wherein the garlic flavorant comprises less than about 5.0% by weight of the refrigerated, raw dough.

4. The refrigerated raw dough product of claim 1, wherein the refrigerated, raw dough is a refrigerated, raw developed dough.

5. The refrigerated raw dough product of claim 1, wherein the refrigerated, raw dough is selected from the group comprising: a crescent roll dough, a biscuit dough, a bread loaf dough, a breadstick dough, a pizza crust dough, a dinner roll dough and a savory bread dough.

6. The refrigerated raw dough product of claim 1, wherein the refrigerated, raw dough is stable for at least 4 weeks of refrigerated storage and the dough, upon baking, has a Baked Specific Volume of at least 2.7 cc/g.

7. The refrigerated raw dough product of claim 6, wherein the refrigerated, raw dough is stable for at least 8 weeks of refrigerated storage and the dough, upon baking, has a Baked Specific Volume of at least 2.7 cc/g.

8. The refrigerated raw dough product of claim 7, wherein the refrigerated, raw dough is stable for at least 12 weeks of refrigerated storage and the dough, upon baking, has a Baked Specific Volume of at least 2.7 cc/g.

9. A process for making a garlic flavored refrigerated dough product comprising:
mixing a combination of dough ingredients to form a raw dough;
applying a garlic flavorant on an exterior portion of the raw dough to form a garlic flavored, refrigerated raw dough product;
preserving the garlic flavored, raw dough product at refrigerated temperatures; and
baking the garlic flavored, refrigerated, raw dough to form a garlic flavored refrigerated dough product having a Baked Specific Volume wherein the Baked Specific Volume exceeds a Second Baked Specific Volume for a comparable second refrigerated dough product having the garlic flavorant mixed directly into the second refrigerated dough product.

10. The process of claim 9, wherein the raw dough comprises a developed dough.

11. The process of claim 9, wherein the garlic flavored, refrigerated raw dough product is selected from the group comprising: a crescent roll, a biscuit, a breadstick, a pizza crust, a dinner roll and a savory bread product.

12. The process of claim 9, further comprising:
forming a raw dough intermediate from the raw dough, wherein the garlic flavorant is applied to the raw dough intermediate.

13. The process of claim 12, wherein forming the raw dough intermediate comprises extruding the raw dough to form a proportioned raw dough intermediate.

14. The process of claim 9, wherein applying the garlic flavorant to the exterior portion of the raw dough comprises applying the garlic flavorant at an end of a production line so as to avoid upstream exposure of the production line to the garlic flavorant.

15. The process of claim 9, wherein applying garlic flavorant comprises applying garlic flavorant selected from the group comprising: minced garlic, granulated garlic, garlic powder, garlic oil and combinations thereof.

16. The process of claim 9, further comprising:
packaging the garlic flavored, refrigerated raw dough product in a package suitable for refrigerated storage.

17. The process of claim 16, wherein the package comprises a pressurized container or low-pressure packaging.

18. The process of claim 9, wherein preserving the garlic flavored, raw dough product at refrigeration temperatures comprises storing the garlic flavored, raw dough product for at least 4 weeks.

19. The process of claim 18, wherein preserving the garlic flavored, raw dough product at refrigeration temperatures comprises storing the garlic flavored, raw dough product for at least 8 weeks.

20. The process of claim 19, wherein preserving the garlic flavored, raw dough product at refrigeration temperatures comprises storing the garlic flavored, raw dough product for at least 12 weeks.
